(19) United States
(12) Patent Application Publication
(10) Pub. No.: US 2001/0014383 A1
(43) Pub. Date: Aug. 16, 2001

(54) Mulch sheet and method of manufacturing the same

(76) Inventors: Bernard Debaux, La Varenne St Hilaire (FR); Jean-Patrick Soumagnas, Voiron (FR)

Correspondence Address: BACON & THOMAS, PLLC, 4th Floor, 625 Slaters Lane, Alexandria, VA, 22314-1176, US

(21) Appl. No.: 09/769,492

(22) Filed: Jan. 26, 2001

(30) Foreign Application Priority Data
Jan. 26, 2000 (FR) 00 01002

(51) Int. Cl. B32B 7/02

(52) U.S. Cl. 428/212

(57) ABSTRACT

The present invention relates to a mulch sheet characterized in that this comprises a tissue layer laminated with a lamination adhesive to a second layer made of another biodegradable sheet, and, in particular, in that the second layer is also a tissue layer.

The invention also relates to a method of manufacturing the mulch sheet.

The present invention relates to a mulch sheet and a method of manufacturing the same.

In the field of agriculture, the advantages of mulching in terms of raising horticultural products has been known for a long time, as it allows for, amongst other things, controlling the growth of seeds and plants, the temperature of the soil and the humidity of the soil, and prevents the growth of weeds as a result, in particular, of the opacity provided thereby, which prevents photosynthesis. In the past, straw was used for mulching, but this was replaced by plastic films, such as polyethylene films, which were colored black. As these films are waterproof, they include perforations, which are made so as to allow for watering and soil drainage. But this drainage is not uniform, and pockets of water form on the film, which encourage the growth of bacteria and negatively impact the growth of the plants. Furthermore, these films are not biodegradable and cannot, therefore, be buried in the ground after use.

More recently, the use of paper covered with a black coat, and in particular, crepe paper or plastic/paper composites has been proposed. The patent U.S. Pat. No. 4,782,626 describes a mulch sheet comprising a sheet of crepe paper covered on both sides by a coating produced from a polyvinylidene chloride dispersion. This coating, which is provided on at least one side of the paper, comprises carbon black to provide opacity. This paper may comprise perforation zones, in accordance with a fairly complex method, so as to facilitate ground drainage.

One of the disadvantages of this paper is that the ground drainage is not uniform. Another disadvantage is that it is all black, and does not blend in well with the agricultural landscape. Another disadvantage is that when the black layer is applied to the sheet, the paper-making machine is dirtied, and must be cleaned before other types of paper are manufactured.

The invention is intended to provide a novel sheet for mulching which does not present the disadvantages of the prior art. In particular, an object of the invention is to provide a sheet which is biodegradable and which allows for the uniform growth of crops.

The invention provides such a mulch sheet characterized in that this comprises a tissue layer laminated by means of an opaque lamination adhesive to a second layer made of another biodegradable sheet.

Preferably, the invention is characterized in that the second layer is also a tissue layer.

The term, tissue layer, is used to mean a layer formed on a paper-making machine from an aqueous suspension of cellulose fibers comprising a wet-strength agent and, possibly, one or more additives, such as a colorant. These fibers are, in particular, fibers resulting from the recycling of paper or cardboard. This layer of fibers is dry-creped, normally after drying thereof. This layer has a relatively open structure, and can have a low weight (in the range of 10 g/m²).

The invention is notable in that it utilizes tissue layers, which have porosity and hydrophilic properties suitable for mulching. Such sheets have the particular advantage, with respect to mulching products of the prior art, of providing a microporous sheet, which allows for uniform irrigation of crops and soil by way of sprinkling. Furthermore, the lamination adhesive provides, to a certain extent, a water evaporation barrier, which encourages water retention by the soil. It has been observed that this combination of factors produces, in particular, a more uniform growth of the crops raised and, therefore, a less pronounced variation in sizes.

Preferably, the mulch sheet is characterized in that the layers are of a weight ranging from 10 to 50 g/m², and in particular, between 15 and 35 g/m². According to a particular embodiment of the invention, the layers are of differing weights.

More particularly, the mulch sheet is characterized in that it has a weight of no greater than 100 g/m².

Another advantage is that the weight of the mulch sheet can be adjusted. It is advantageous that the weight be as low as possible, as this allows a larger surface area of sheeting to be rolled onto a roll of a given weight. It is nonetheless necessary that the weight be sufficient for the sheet to have a sufficient mechanical strength. Generally, the mulch sheet is placed on the ground by unwinding a roll which is placed in an unwinder at the back of a tractor, so that the sheet unwinds in accordance with the forward movement of the tractor. Small wheels suitably placed at the level of the unwinder allow the sheet to be placed on the ground and then to have the edges thereof buried in furrows plowed by plowshares which are also positioned at the level of the unwinder.

Preferably, the sheet is characterized in that the layers present a stretch at breaking point of 20 to 30% in the running direction of the paper-making machine, as measured in accordance with the international standard ISO 1924-2/07-1995 (paragraph 10.5). Mulch sheets comprising layers which have a good stretch at breaking point provide good drapability when these are placed on ground to be cultivated.

Another advantage is that the layers can be colored, and can be the same color or different colors. This coloring contributes to the opacity of the mulch sheet. They can be colored in a color which goes well with the color of the crop. The sheet according to the invention is characterized, in particular, in that the layers are colored and, in particular, in that they are colored brown.

Another advantage is that biodegradability of the sheet can be adjusted by way of the lamination adhesive, as the result of the corresponding choice of the type components used in this adhesive, and the respective properties thereof, as well as by the quantity of adhesive used. The components can be more or less rapidly biodegradable. In general, the biodegradability of the sheet is adjusted in accordance with the growing period, that is to say, so that the sheet decomposes when the plants have finished growing. The sheet can also be buried in the ground.

In general, this lamination adhesive is prepared in an aqueous medium, and comprises a binder chosen from amongst polymers which are used as aqueous dispersions, and an opacifying agent.

Preferably, the sheet according to the invention is characterized in that the lamination adhesive comprises:

5 to 25% of an opacifying agent, and in particular carbon black;

15 to 85% of a polymer binder as a stabilized aqueous dispersion, in particular chosen from amongst styrene-butadiene, carboxylated styrene-butadiene and styrene-acrylic copolymers, or acrylic polymers;

0 to 25% of another organic binder, in particular chosen from amongst starch, polyvinyl alcohol, casein, alginates, cellulose derivatives and gelatin;

0 to 70% of other fillers, and in particular, mineral fillers, chosen from amongst calcium, kaolin and talc; and

0 to 25% of a thickener,

these percentages being dry-weight percentages with respect to the overall dry-weight of the adhesive, and the sum of these percentages being 100.

If necessary, the adhesive may comprise an anti-foaming agent and dispersion agents.

The lamination adhesive is applied at a rate of 4 to 40 g/m², and preferably 5 to 20 g/m², in dry-weight.

The lamination adhesive may also comprise fertilizers, herbicides and, in particular, selective herbicides. An advantage of such a sheet is that it can present different characteristics on either side. In particular, it may present differing thermal capacities in accordance with the differing adsorption of adhesive by the two layers of which it is composed. Thus, the darker side, which absorbs more heat, would be placed at the exterior, so as to encourage the growth of the plants, and the lighter side would be placed in contact with the soil, so that it absorbs less heat from the soil. Conversely, in a very hot season, one may wish to protect the plants from heat, and in this case the darker side would be placed facing the soil.

The invention also provides a method of manufacturing the mulch sheet.

One method of manufacturing the mulch sheet is characterized in that:

a first tissue layer is unwound;

this first tissue layer is coated with the lamination adhesive; and then,

the second layer is stuck onto the adhesive; and then,

the mulch sheet obtained in this manner is dried.

Another method of manufacturing the mulch sheet is characterized in that:

a first tissue layer is unwound;

this first tissue layer is coated with the lamination adhesive; and then,

the layer coated in this manner is fed through a drying tunnel;

the second layer is applied on the hot adhesive so as to form the mulch sheet.

Another method of manufacturing the mulch sheet is characterized in that:

a first tissue layer is unwound;

this first tissue layer is coated with the lamination adhesive, then dried; and then,

the cooled, coated layer is rolled;

the coated layer is unwound and fed through a heating cylinder; and

the second layer is applied on the hot adhesive so as to form the mulch sheet.

In these methods, the second layer can, conversely, be coated with the lamination adhesive and the tissue layer can be applied thereto.

According to a particular embodiment of the invention, any one of these methods is characterized in that the lamination adhesive is applied by silkscreen. The use of silkscreen is advantageous, as the adhesive can be used as a fairly viscous composition which allows for application without seeping through the tissue layers, which are highly porous.

This method of manufacturing the mulch sheet is characterized, in particular, by the fact the silkscreen apparatus comprises at least two rotating screens. Here, in order to improve the characteristics of the mulch sheet, one may wish to apply the adhesive by means of two (or more) rotating screens. For example, the first rotating screen is etched so as to reinforce the lateral tearing strength of the sheet, which can be achieved if the etched pattern takes the form of bars, perpendicular to the running direction of the first layer, which allows for stripes of adhesive to be applied crosswise to the sheet; and the second rotating screen is etched so as to produce a homogeneous opacity, the etched pattern allowing for uniform application of the adhesive.

The invention will be better understood by way of the following non-limiting examples.

### EXAMPLE 1

Using an aqueous suspension of recycled cellulose fibers containing 0.2% in dry-weight of a wet-strength agent and a brown colorant, a tissue layer of cellulose fibers is produced with a Fourdrinier machine. After formation, this layer is dried, dry-creped, and rolled. This has a weight of 30 g/m², measured in accordance with the international standard ISO 536. It has a Guerley porosity of 0.5 s, as measured in accordance with the standard NF-ISO 5636-5/03-1998, using, as the sheets are very porous, a stack of 8 sheets, and calculated for one sheet by dividing the result by 8. It has a stretch at breaking point of 25% in the running direction of the paper-making machine, as measured according to the international standard ISO 1924-2/07-1995 (paragraph 10.5). The layer is brown; more precisely, fawn. The thickness thereof is 105 μm, as measured in accordance with the international standard ISO 534.

The same tissue layer is used for the second layer.

The first layer is unwound on a laminator, the lamination adhesive described below is applied thereto at a rate of 10 g/m² in dry-weight, and, immediately thereafter, the second layer is applied on this adhesive. The laminated sheet is pressed and dried at approximately 100 to 120° C.

The lamination adhesive was prepared in an aqueous medium by means of dispersing various components.

Contained in 10 g of adhesive are, in dry-weight:

2.5 g of a styrene-butadiene copolymer which is used as a stable aqueous dispersion thereof (latex);

1.5 g of starch;

1 g of carbon black;

4.5 g of calcium carbonate pigment; and

0.5 g of a thickener.

The sheet produced in this manner has an opacity of 99%, as measured according to the international standard ISO 2471/1983. It has a Guerley porosity of 3 s, measured under the same conditions as those described above. The two sides of the sheet are different in appearance: that is to say, the side comprising the first layer to have been coated appears brown and black, but more black than the other side, which comprises the second tissue layer.

The mulch sheet is tested in raising salad vegetables in a greenhouse, in comparison with a black polyethylene film for mulching. The blackest side of the sheet is placed on the exterior (opposite side facing ground).

The average weight of the salad vegetables obtained with the plastic film is 456 g, and the weight of the salad vegetables raised using the sheet according to the invention is 460 g. This shows that the mulch sheet according to the invention is as effective as, or slightly more effective than, a polyethylene mulch film.

Furthermore, the coefficient of variation for the weight of 20 salad vegetables in the first case is 12.1%, while in the case relating to the invention, it is only 9.5%. This shows that the growth of the salad vegetables, and therefore their size, is more uniform with a mulch sheet according to the invention.

Furthermore, the sheet according to the invention biodegrades when growing ends, that is to say, after six weeks.

### EXAMPLE 2

Tissue layers are prepared as in example 1, and the same lamination adhesive is used, but the mulch sheet is manufactured by means of a different lamination method. After having coated the first layer with adhesive, this layer is fed through a drying tunnel at 120° C., and the second tissue layer is applied at the exit of the tunnel. The advantage of this method is that the layer of adhesive has had the chance to form properly and spread homogeneously, so a better stretch at breaking point is maintained.

### EXAMPLE 3

Tissue layers produced in the same manner as in example 1 are used, but a different lamination adhesive is used, which does not comprise a mineral filler. This adhesive has the following composition, as given in dry-weight for 10 g of adhesive:

6.78 g of a styrene-butadiene copolymer which is used as a stable aqueous dispersion thereof (latex);

1.88 g of carbon black; and

0.5 g of a thickener.

The mulch sheet is manufactured according to the following lamination method: the first tissue layer is coated with this adhesive by means of silkscreen, in two passes, using two rotating screens, the first screen allows for application of the adhesive in stripes perpendicular to the running direction of the layer, and the second screen allows for uniform application of the adhesive over the entire surface of the layer. The second layer is then applied to form the mulch sheet. The sheet is pressed and dried at approximately 100 to 120° C.

1. A mulch sheet characterized in that this comprises a tissue layer laminated with an opaque laminating adhesive to a second layer made of another biodegradable sheet.

2. A mulch sheet according to claim 1, characterized in that said second layer is a tissue layer.

3. A mulch sheet according to one of claims 1 or 2, characterized in that said layers have a weight within the range of 10 to 50 g/m², in particular, between 15 and 35 g/m².

4. A sheet according to one of claims 1 to 3, characterized in that said layers have different weights.

5. A sheet according to one of claims 1 to 4, characterized in that this has a weight of no more than 100 g/m².

6. A sheet according to one of claims 1 to 5, characterized in that said layers have a stretch at breaking point of 20 to 30% in the running direction of the paper-making machine, as measured in accordance with the international standard ISO 19242/07-1995 (paragraph 10.5).

7. A sheet according to one of claims 1 to 6, characterized in that said layers are colored, in particular, colored brown.

8. A sheet according to one of claims 1 to 7, characterized in that said lamination adhesive comprises:
5 to 25% of an opacifying agent, in particular carbon black, in dry-weight, with respect to the total weight of the adhesive;
15 to 85% of a polymer binder, as a stabilized aqueous dispersion, in particular chosen from amongst styrene-butadiene, carboxylated styrene-butadiene and styrene-acrylic copolymers, or acrylic polymers;
0 to 25% of another organic binder, in particular chosen from amongst starch, polyvinyl alcohol, casein, alginates, cellulose derivatives and gelatin;
0 to 70% of other fillers, in particular, mineral fillers chosen from amongst calcium, kaolin and talc; and
0 to 25% of a thickener,
these percentages being dry-weight percentages with respect to the overall dry-weight of the adhesive, and the sum of these percentages being 100.

9. A sheet according to one of claims 1 to 8, characterized in that the lamination adhesive is applied at a rate of 4 to 40 g/m², in dry-weight, preferably 5 to 20 g/m².

10. A method of manufacturing the mulch sheet according to one of claims 1 to 9, characterized in that:
a first tissue layer is unwound;
this first tissue layer is coated with said lamination adhesive; and then,
said second layer is applied on the adhesive; and then,
the mulch sheet obtained in this manner is dried.

11. A method of manufacturing the mulch sheet according to one of claims 1 to 9, characterized in that:
a first tissue layer is unwound;
said layer is coated with said lamination adhesive; and then,
the layer coated in this manner is fed through a drying tunnel;
said second layer is applied on the hot adhesive so as to form the mulch sheet.

12. A method of manufacturing the mulch sheet according to one of claims 1 to 9, characterized in that:
a first tissue layer is unwound;
said layer is coated with said lamination adhesive, then dried; and then,
the cooled, coated layer is rolled;
the coated layer is unwound and fed through a heating cylinder; and
said second layer is applied on the hot adhesive so as to form the mulch sheet.

13. A method of manufacturing a mulch sheet according to one of claims 10 to 12, characterized in that said lamination adhesive is applied by means of silkscreen.

14. A method of manufacturing a mulch sheet according to claim 13, characterized in that the silkscreen apparatus comprises at least two rotating screens.
